(19) United States
(12) Patent Application Publication
(10) Pub. No.: US 2020/0076085 A1
(43) Pub. Date: Mar. 5, 2020

(54) HORN ANTENNA, ANTENNA ARRAY, AND RADAR

(71) Applicants: Nidec Corporation, Kyoto (JP); WGR Co., Ltd., Kyoto-city (JP)

(72) Inventors: Hiroyuki KAMO, Kyoto (JP); Hideki KIRINO, Kyoto-city (JP)

(21) Appl. No.: 16/554,920

(22) Filed: Aug. 29, 2019

(30) Foreign Application Priority Data
Aug. 31, 2018 (JP) 2018-163578

(51) Int. Cl. H01Q 13/02; H01Q 13/08; H01Q 1/32

(52) U.S. Cl. CPC H01Q 13/0233; H01Q 1/3208; H01Q 13/0275; H01Q 13/085

(57) ABSTRACT

A horn antenna includes a horn including a horn inner surface and a horn bottom including a horn bottom surface. The horn bottom includes a radiation portion which emits a radio wave at a position that deviates from the center of the horn bottom surface. The horn bottom surface extends farther in a first direction. The position of the radiation portion deviates from the center of the horn bottom surface in the first direction. The radiation portion is a slot which is opened in the horn bottom surface. A direction of supplying power to the slot is a second direction which is in parallel or substantially in parallel with the horn bottom surface and perpendicular or substantially perpendicular to the first direction.

### CROSS REFERENCE TO RELATED APPLICATION

The present invention claims priority under 35 U.S.C. § 119 to Japanese Application No. 2018-163578 filed on Aug. 31, 2018 the entire content of which is incorporated herein by reference.

### 1. FIELD OF THE INVENTION

The present invention relates to a horn antenna and a radar including the horn antenna.

### 2. BACKGROUND

In recent years, a radar is mounted on a vehicle for the purpose of prevention of accidents or autonomous driving of the car. Improvements of the in-vehicle radar have been actively made. The in-vehicle radar monitors the surroundings of the vehicle by using, for example, a millimeter wave. As an antenna of the radar, preferably, a horn antenna is used. One of such antennas is disclosed in Japanese Patent Application Laid-Open No. 2004-125746.

In a horn of a horn antenna shown in FIG. 4 of Japanese Patent Application Laid-Open No. 2004-125746, a waveguide tube is extended from the back side toward the front as the horn is viewed when the viewer faces an opening of the horn. Left and right walls and a lower wall of the horn are directly extended toward the front continuously from the waveguide tube. An upper wall of the horn is extended, being inclined upward. In other words, the horn is extended symmetrically in an X direction and asymmetrically in a Y direction. It is thereby possible to incline a radiation direction of a radio wave. For example, radiation of a radio wave downward is suppressed.

In the horn antenna disclosed in Japanese Patent Application Laid-Open No. 2004-125746, since the width of the horn in the X direction is the same as the width of the waveguide tube, it is difficult to expand a bandwidth of a radio wave emitted from the opening of the horn to a free space.

Further, in the horn antenna disclosed in Japanese Patent Application Laid-Open No. 2004-125746, a direction in which the waveguide tube is extended coincides with a direction in which the opening of the horn is directed. For this reason, in order to arrange the horn antenna, a large space is needed in a depth direction. Such a structure is not suitable for the in-vehicle radar since a setting space therefor in the depth direction is limited.

### SUMMARY

Example embodiments of the present disclosure provide a horn antenna which is capable of inclining a radiation direction of a radio wave and easily ensuring a bandwidth.

Example embodiments of the present disclosure provide horn antennas. A horn antenna according to one example embodiment of the present disclosure includes a horn including a horn inner surface and a horn bottom including a horn bottom surface. In the horn antenna of an example embodiment of the present disclosure, the horn bottom includes a radiation portion which emits a radio wave at a position that deviates from the center of the horn bottom surface.

According to example embodiments of the present disclosure, it is possible to incline a radiation direction of a radio wave and easily ensure a bandwidth.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a plan view showing a horn antenna according to an example embodiment of the present disclosure.

FIG. 2 is a longitudinal section of the horn antenna taken at the position of II-II of FIG. 1.

FIG. 3 is a plan view showing a variation of the horn antenna.

FIG. 4 is a plan view showing another variation of the horn antenna.

FIG. 5 is a plan view showing still another variation of the horn antenna.

FIG. 6 is a plan view showing yet another variation of the horn antenna.

FIG. 7 is a plan view showing a further variation of the horn antenna.

FIG. 8 is a graph showing a radiation characteristic of the horn antenna.

FIG. 9 is a graph showing a radiation characteristic of the horn antenna.

FIG. 10 is a graph showing a radiation characteristic of the horn antenna.

FIG. 11 is a perspective view showing another preferable horn antenna according to an example embodiment of the present disclosure.

FIG. 12 is a plan view showing the horn antenna of FIG. 11.

FIG. 13 is a plan view showing a variation of the horn antenna.

FIG. 14 is a plan view showing another variation of the horn antenna.

FIG. 15 is a plan view showing a horn antenna having another structure according to an example embodiment of the present disclosure.

FIG. 16 is a perspective view showing still another variation of the horn antenna shown in FIG. 12.

FIG. 17 is a plan view showing an antenna array according to an example embodiment of the present disclosure.

FIG. 18 is a perspective view showing another example of a waveguide according to an example embodiment of the present disclosure.

FIG. 19 is a perspective view showing another exemplary case where a plurality of horn antennas are arranged on the waveguide.

FIG. 20 is a perspective view showing still another example of the waveguide together with the antenna array.

FIG. 21 is a perspective view of a conductive member which is a portion of the waveguide shown in FIG. 20.

FIG. 22 is a perspective view showing still another preferable horn antenna according to an example embodiment of the present disclosure.

FIG. 23 is a view showing components of a radar according to an example embodiment of the present disclosure.

FIG. 24 is a view showing a vehicle including the radar.

FIG. 25 is a perspective view of the radar.

FIG. 26 is an elevation view of the radar.

FIG. 27 is a plan view showing a first conductive member according to an example embodiment of the present disclosure.

FIG. 28 is a plan view showing a second conductive member according to an example embodiment of the present disclosure.

FIG. 29 is a plan view showing a third conductive member according to an example embodiment of the present disclosure.

FIG. 30 is an enlarged view of receiving antennas according to an example embodiment of the present disclosure.

### DETAILED DESCRIPTION

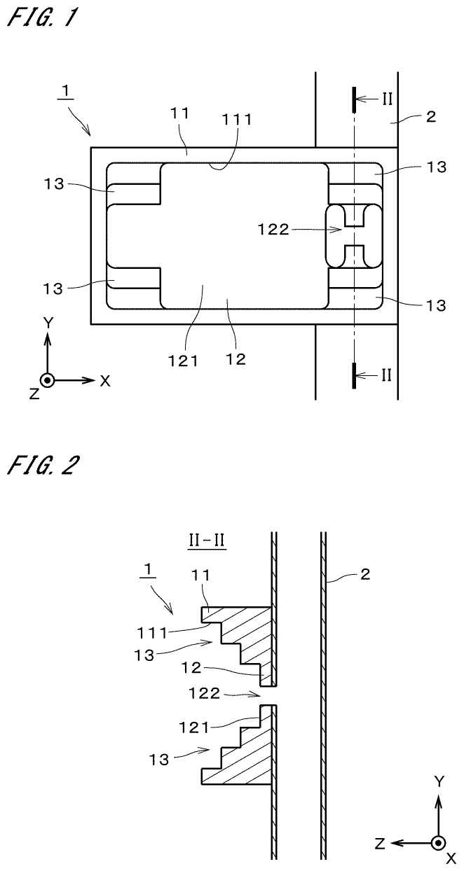

FIG. 1 is a plan view showing a horn antenna 1 in accordance with one example embodiment of the present disclosure. FIG. 1 also shows a waveguide 2 which is a waveguide tube. The horn antenna 1 is arranged on the waveguide 2. FIG. 2 is a longitudinal section of the horn antenna 1 taken at the position of II-II of FIG. 1. As shown in FIGS. 1 and 2, the horn antenna 1 includes a horn 11 and a horn bottom 12. The horn 11 and the horn bottom 12 are formed by cutting one metal member. The horn 11 and the horn bottom 12 may be formed by any method other than cutting. The horn 11 includes a horn inner surface 111 which is an inner surface of the horn 11. The horn bottom 12 includes a horn bottom surface 121 which is an upper surface of the horn bottom 12. The horn 11 protrudes upward from an outer peripheral portion of the horn bottom 12.

The horn bottom 12 further includes a radiation part 122. The radiation part 122 emits a radio wave. The radiation part 122 is provided at a position that deviates from the center of the horn bottom surface 121. Therefore, the radiation part 122 emits the radio wave at the position that deviates from the center of the horn bottom surface 121. In the present example embodiment, the radiation part 122 is a slot which is opened in the horn bottom surface 121. The radiation part 122 has an H shape. The H shape has a lateral portion directed in an X direction and a pair of vertical portions. The pair of vertical portions are connected by the lateral portion. Providing the radiation part 122 at the position that deviates from the center of the horn bottom surface 121 means that the position of the center of the radiation part 122 is different from the position of the center of the horn bottom surface 121.

An X direction and a Y direction shown in FIG. 1 are in parallel with the horn bottom surface 121. The X direction and the Y direction are perpendicular to each other. A Z direction is perpendicular to the X direction and the Y direction. In other words, the Z direction is perpendicular to the horn bottom surface 121.

The horn antenna 1 further includes steps 13. Each step 13 protrudes from the horn bottom surface 121 and the horn inner surface 111 as shown in FIG. 2. In the exemplary case shown in FIG. 2, the step 13 has two stages, i.e., the step 13 has two sub-steps. In the following description, the respective shapes of the horn inner surface 111 and the horn bottom surface 121 refer to shapes thereof in a case where there is no step 13. Therefore, the horn bottom surface 121 has a substantially rectangular shape, and the horn inner surface 111 rises from each side of the horn bottom surface 121 toward a (+Z) direction. In FIG. 1, four steps 13 are provided at four corners of the rectangular horn bottom surface 121. The shapes of the two steps 13 on a (+Y) side are the same as each other except details. The shapes of the two steps 13 on a (−Y) side are the same as each other except details. The shapes of the two steps 13 on the (+Y) side and the shapes of the two steps 13 on the (−Y) side are symmetrical with respect to a plane of symmetry which is a plane in parallel with the X direction and perpendicular to the horn bottom surface 121 and passes through the center of the horn bottom surface 121.

In the present example embodiment, the horn bottom 12 and the horn bottom surface 121 each have a substantially rectangular shape. The horn bottom surface 121 is long in the X direction that is a first direction. In other words, a direction in which the long side of the rectangular shape extends is the X direction. The position of the radiation part 122 deviates in a (+X) direction from the center of the horn bottom surface 121. The two steps 13 on the (+Y) side protrude in two stages in the (+Z) direction as goes toward a (+Y) direction. The two steps 13 on the (−Y) side protrude in two stages in the (+Z) direction as goes toward a (−Y) direction. The two steps 13 on a (+X) side are positioned between the radiation part 122 and the horn inner surface 111 in the Y direction.

The waveguide 2 is a tube formed of a metal. The waveguide 2 extends in the Y direction that is a second direction. The slot which is the radiation part 122 is opened down to the inside of the waveguide 2. In other words, an opening of the radiation part 122 is continuous to the waveguide 2. A direction in which power is supplied to the slot by the waveguide 2 is the Y direction. The slot has an H shape directed in the Y direction. In other words, the slot is provided so that an up-and-down direction of the H shape may be in parallel with the Y direction.

In the present example embodiment, by providing the radiation part 122 at the position that deviates from the center of the horn bottom surface 121, it is possible to incline a direction of a main lobe from the front direction by the simple structure. The front direction is the (+Z) direction. The radiation direction of a radio wave in the following description refers to the direction of the main lobe. In the exemplary case shown in FIG. 1, since the radiation part 122 is provided at the position that deviates toward the (+X) side from the center of the horn bottom surface 121, the main lobe of the emitted radio wave is inclined toward a (−X) direction from the (+Z) direction. Particularly, by deviating the position of the radiation part 122 in the X direction that is a longitudinal direction of the horn bottom surface 121, it is possible to incline the radiation direction of the radio wave more effectively. It is possible, for example, to incline the radiation direction of the radio wave at 10 to 30 degrees with respect to a normal of the horn bottom surface 121.

From the viewpoint of inclining the radiation direction of the radio wave, it is preferable that the height of the horn 11, i.e., the height of the horn inner surface 111 should be lower. Preferably, the height of the horn 11 is lower than twice a wavelength at a center frequency of a frequency band of the radio wave emitted from the radiation part 122. In a case of using a band of millimeter wave which has a center frequency of 76 GHz, for example, the height of the horn 11 is preferably lower than 8 mm, and more preferably not higher than 5 mm. It is preferable that the height of the horn 11 should be not lower than 3.5 mm. The height of the horn 11 refers to the height of the horn 11 from the horn bottom surface 121 in a direction perpendicular to the horn bottom surface 121. Further, since the horn bottom surface 121 is present in at least part of the periphery of the radiation part 122, it is possible to easily ensure a bandwidth of the radio wave to be emitted. It is thereby possible to transmit and receive a large amount of information.

Since the slot which is the radiation part 122 has an H shape, it is possible to suppress the width of the radiation part 122 in the X direction to be smaller as compared with a case where the radiation part 122 has a transversely-laid I shape (see FIG. 3). As a result, the center of the radiation part 122 can be made closer to the horn inner surface 111 on the (+X) side. On design, a selection range of the position of the radiation part 122 is increased.

In the horn antenna 1, since the power supply direction is the Y direction, it is possible to suppress the height of a setting space of the horn antenna 1 in the Z direction to be lower as compared with a case where power is supplied in the Z direction. By providing the step 13 in the horn antenna 1, it is possible to match the impedances on a power supply side and a radiation side, to thereby efficiently emit the radio wave.

FIG. 3 is a plan view showing a variation of the horn antenna 1 shown in FIG. 1. The horn antenna 1 of FIG. 3 has a configuration in which a slot shape of the radiation part 122 of the horn antenna 1 of FIG. 1 has a transversely-laid I shape. In other words, the slot is linear extending in the X direction. The I-shaped slot can be easily formed by cutting.

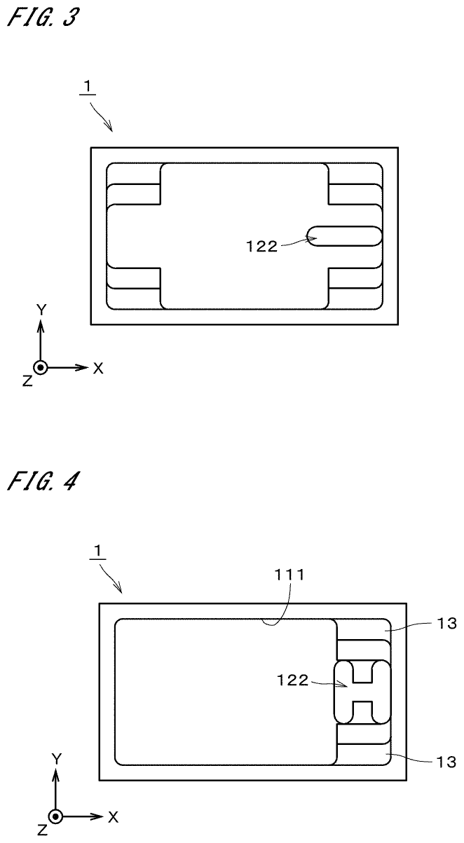

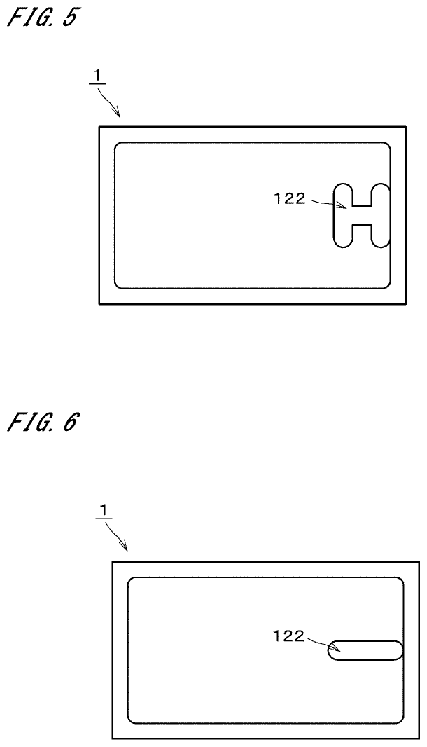

FIG. 4 is a plan view showing another preferable variation of the horn antenna 1 shown in FIG. 1. The horn antenna 1 of FIG. 4 is a horn antenna in which the two steps 13 which are away from the radiation part 122 are omitted from the horn antenna 1 of FIG. 1. Specifically, the steps 13 are provided only between the radiation part 122 and the horn inner surface 111 in the Y direction. Since the degree of contribution of the steps 13 away from the radiation part 122 to the inclination of the radiation direction of the radio wave and the radiation efficiency is small, the steps 13 on the (−X) side which are provided at positions away from the radiation part 122 can be omitted.

FIG. 5 is a plan view showing an exemplary case in which all the steps 13 are omitted from the horn antenna 1 of FIG. 1. It is not always necessary to provide the steps 13, depending on the size or the shape of the horn antenna 1 or the wavelength of the emitted radio wave. Specifically, if impedance matching is made, no step 13 may be provided. Even in a case where the number of steps 13 is 2 or in a case where the number of steps 13 is 0, the shape of the radiation part 122 may be changed from the H shape to the transversely-laid I shape. FIG. 6 is a view showing an exemplary case where the shape of the radiation part 122 is the transversely-laid I shape in the case where the number of steps 13 is 0.

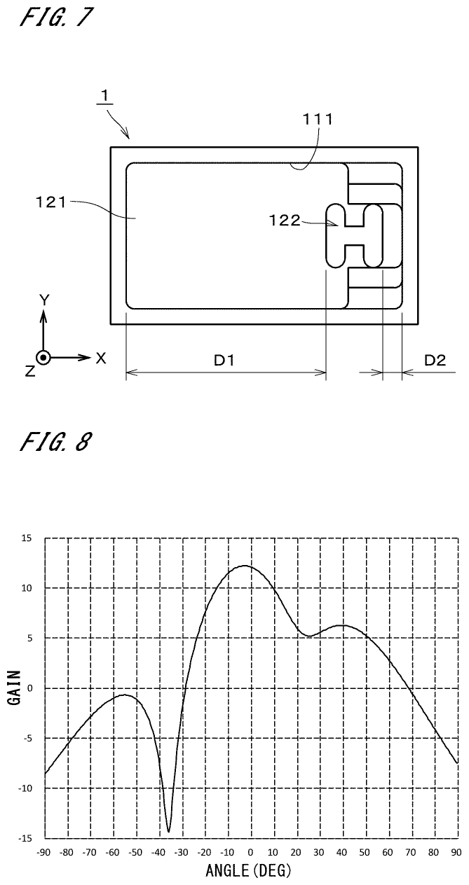

FIG. 7 is a plan view showing an exemplary case where the radiation part 122 is placed further away from the horn inner surface 111 in the (−X) direction as compared with the case of FIG. 1. Specifically, in FIG. 7, the radiation part 122 is closer to the center of the horn bottom surface 121 than that in the case of FIG. 1. The radiation part 122 does not always need to be placed at the endmost in the horn bottom surface 121. In a case, for example, where a distance between a plane of the horn inner surface 111, which is positioned on the (+X) side, and another plane of the horn inner surface 111, which is positioned on the (−X) side, is 9 mm and the width of the radiation part 122 in the X direction is 1.5 mm, the left end of the radiation part 122 has only to deviate from the center of the horn bottom surface 121, for example, in a range of 0.1 mm to 3 mm on the (+X) side, and more preferably in a range of 1 mm to 2 mm. Further, the distance by which the radiation part 122 deviates from the center of the horn bottom surface 121 in the X direction may be changed as appropriate in accordance with the width of the horn 11 in the X direction and the width of the radiation part 122 in the X direction. In order to adjust the degree of inclination of the emitted radio wave, the position of the radiation part 122 may be determined as appropriate inside the horn bottom surface 121.

FIGS. 8 to 10 are graphs showing variations in the radiation characteristic in cases where the position of the radiation part 122 in the horn bottom surface 121 is changed in the horn antenna 1 of FIG. 7. The width of the horn bottom surface 121 in the Y direction is about 5 mm and a distance D1 from the left end of the radiation part 122 to a plane of the horn inner surface 111 on a (−X) side is about 5 mm. The height of the horn inner surface 111 inside the horn is about 4 mm.

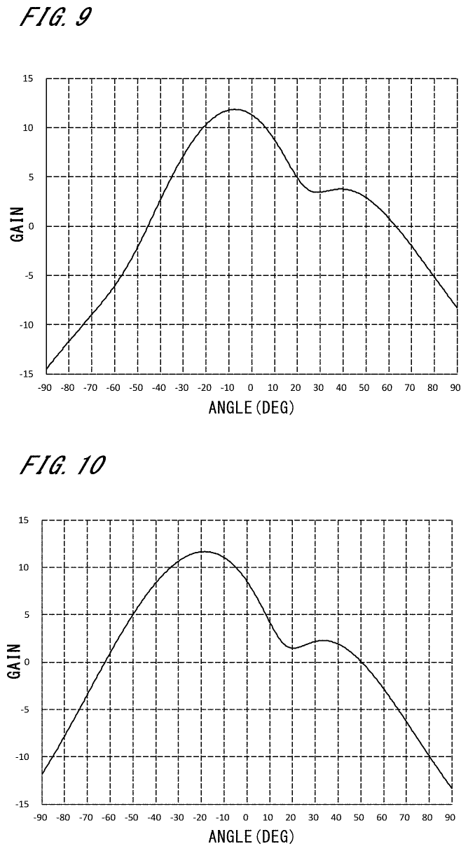

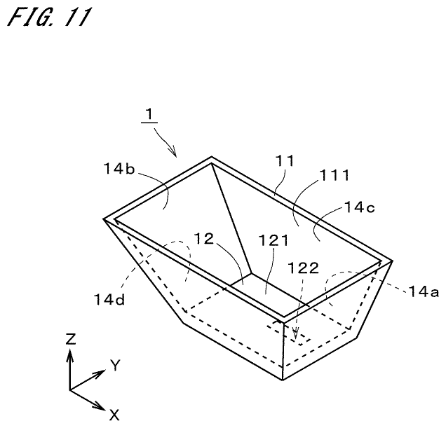

FIG. 8 is a graph showing a radiation characteristic in a case where a distance D2 from the right end of the radiation part 122 to a plane of the horn inner surface 111 on the (+X) side is set to be 2.0 mm. FIG. 9 is a graph showing a radiation characteristic in a case where the distance D2 is set to be 1.6 mm. FIG. 10 is a graph showing a radiation characteristic in a case where the distance D2 is set to be 1.0 mm.

As shown in FIGS. 8 to 10, an angle at which a gain becomes maximum is changed by the change of the distance D2. Since the angle at which the gain becomes maximum is near 0 degrees in FIG. 8 and the angle at which the gain becomes maximum is near −20 degrees in FIG. 10, it can be seen that the tilt angle of the emitted radio wave is changed by about 20 degrees by changing the distance D2 by 1.0 mm. From this point, it can be thought that the distance between the plane of the horn inner surface 111, which is positioned on a side where the radiation part 122 deviates to be disposed, and the radiation part 122 has a large effect on the degree of inclination of the emitted radio wave. In other words, in the case where the radiation part 122 is disposed, deviating from the center of the horn bottom surface 121 in a predetermined direction, in order to incline the radiation direction of the radio wave, it is important to adjust the distance between the radiation part 122 and the horn inner surface 111 in the predetermined direction side of the radiation part 122.

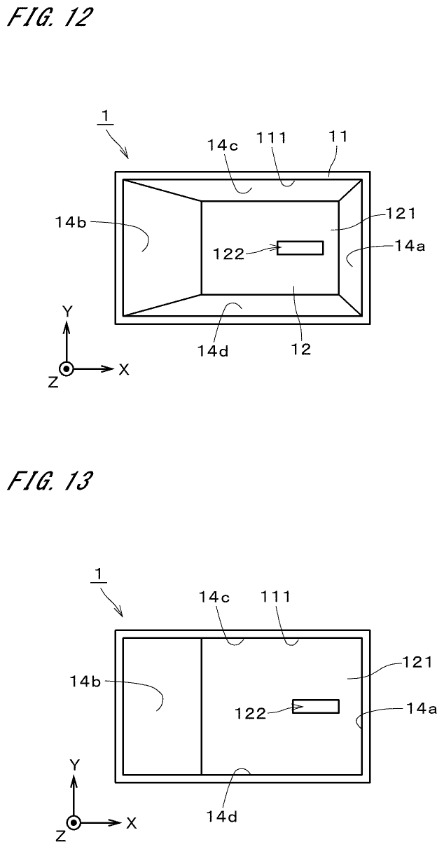

FIG. 11 is a perspective view showing the horn antenna 1 in accordance with another example embodiment. FIG. 12 is a plan view showing the horn antenna 1 of FIG. 11. The height of the horn 11 of the horn antenna 1 shown in FIGS. 11 and 12 is higher than that of the horn 11 of the horn antenna 1 shown in FIGS. 1 and 2. The horn bottom 12 has a rectangular shape. The horn bottom 12 includes the radiation part 122 having a transversely-laid I shape. The radiation part 122 is a slot. The position of the radiation part 122 deviates from the center of the horn bottom surface 121 in the (+X) direction. The horn antenna 1 of FIG. 5 has no step 13 shown in FIG. 1.

In FIGS. 11 and 12, a portion of the horn inner surface 111 of the horn antenna 1, which rises from a side of the horn bottom surface 121 on the (+X) side, is represented by reference sign 14a. A portion thereof which rises from a side of the horn bottom surface 121 on the (−X) side is represented by reference sign 14b. A portion thereof which rises from a side of the horn bottom surface 121 on the (+Y) side is represented by reference sign 14c. A portion thereof which rises from a side of the horn bottom surface 121 on the (−Y) side is represented by reference sign 14d. The portions 14a, 14b, 14c, and 14d are each inclined outward in the (+Z) direction. The portion 14b is inclined most. In other words, a portion of the horn inner surface 111, which rises from a position farthest away from the radiation part 122, is inclined more than any other portions, toward a direction becoming farther away from the normal of the horn bottom surface 121 as it becomes farther away from the horn bottom surface 121.

Even in the horn antenna 1 of FIGS. 11 and 12, by deviating the position of the radiation part 122 from the center of the horn bottom surface 121, it is possible to easily incline the radiation direction of the radio wave. Further, by inclining the horn inner surface 111 as above, in cooperation with deviation of the position of the radiation part 122 from the center of the horn bottom surface 121, it is possible to incline the radiation direction of the radio wave more efficiently. Since the horn bottom surface 121 is present around the radiation part 122, it is possible to easily ensure the bandwidth. As to the point that the radiation direction of the radio wave from the horn antenna 1 can be inclined by the simple structure and the bandwidth can be easily ensured, the same applies to other example embodiments and variations described below.

Though not shown in the figures, also in the horn antenna 1 of FIGS. 11 and 12, the waveguide 2 extending in the Y direction is connected to the radiation part 122. Since the power supply direction is the Y direction, it is possible to suppress the height of the setting space of the horn antenna 1 in the Z direction to be smaller as compared with the case where power is supplied in the Z direction.

FIG. 13 is a plan view showing a preferable variation of the horn antenna 1 shown in FIGS. 11 and 12. In the horn antenna 1 of FIG. 13, the portions 14a, 14c, and 14d of the horn inner surface 111 are in parallel with the Z direction. In other words, the portions 14a, 14c, and 14d are in parallel with the normal of the horn bottom surface 121. Only the portion 14b is inclined outward with respect to the normal of the horn bottom surface 121. Thus, the portions 14a, 14c, and 14d do not always need to be inclined.

In the horn antenna 1 shown in FIGS. 12 and 13, from the viewpoint of inclining the direction of the emitted radio wave effectively in the X direction, the relation in the inclination between the portions 14a and 14b is important. The portion 14a of the horn inner surface 111, which rises from a position closest to the radiation part 122, is in parallel with the normal of the horn bottom surface 121 or inclined toward the direction becoming farther away from the normal as it becomes farther away from the horn bottom surface 121. In contrast to this, preferably, the portion 14b of the horn inner surface 111, which rises from a position farthest away from the radiation part 122, is inclined more than the portion 14a, toward the direction becoming farther away from the normal of the horn bottom surface 121 as it becomes farther away from the horn bottom surface 121.

Further, since forming part of the horn 11 by processing becomes easier if part of the horn inner surface 111 is in parallel with the normal of the horn bottom surface 121, it is preferable that at least part of the horn inner surface 111 other than the portion 14b which rises from the position farthest away from the radiation part 122 should be in parallel with the normal. As shown in FIG. 13, it is more preferable that all the portions other than the portion 14b should be in parallel with the normal of the horn bottom surface 121.

Furthermore, though the above description has been made on the premise that the horn bottom 12 and the horn bottom surface 121 each have a rectangular shape or a substantially rectangular shape, the respective shapes of the horn bottom 12 and the horn bottom surface 121 are not limited to these shapes. The horn bottom 12 and the horn bottom surface 121 may each have, for example, a rectangular shape having a large C-chamfered or R-chamfered corner. The horn bottom 12 and the horn bottom surface 121 may be ellipse. Further, the horn bottom 12 and the horn bottom surface 121 may not be long in the X direction. The horn bottom 12 and the horn bottom surface 121 may be, for example, square or circle. The horn bottom 12 and the horn bottom surface 121 may have shapes which are largely different from each other.

Even if the horn bottom 12 and the horn bottom surface 121 each have any one of various shapes described above, by deviating the position of the radiation part 122 from the center of the horn bottom surface 121, it is possible to easily incline the radiation direction of the radio wave. Further, by inclining the portion of the horn inner surface 111, which is farthest away from the radiation part 122, outward more than the other portions, it is possible to incline the radiation direction of the radio wave more efficiently.

The portion of the horn inner surface 111, which is farthest away from the radiation part 122, may be so inclined as to be perpendicular to the normal of the horn bottom surface 121. In this case, the horn 11 has a shape in which the portion farthest away from the radiation part 122 is substantially eliminated. In the exemplary cases shown in FIGS. 12 and 13, for example, the horn inner surface 111 has a shape in which the portion 14b is not present.

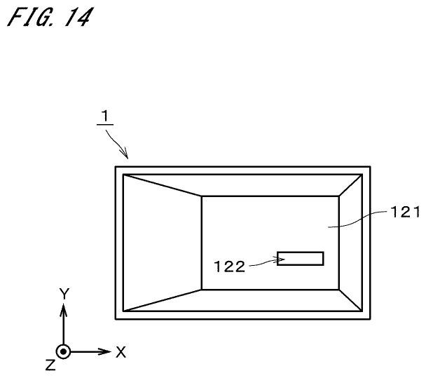

FIG. 14 is a view showing a preferable variation of the horn antenna 1 shown in FIG. 12. In the horn antenna 1 of FIG. 14, the position of the radiation part 122 deviates from the center of the horn bottom surface 121 in the (+X) direction and the (−Y) direction. Other structure of the horn antenna 1 of FIG. 14 is the same as that of FIG. 12. Thus, the position of the radiation part 122 does not always need to deviate only in the X direction. If the emitted radio wave has required characteristics, the position of the radiation part 122 may be changed into various forms on the horn bottom surface 121.

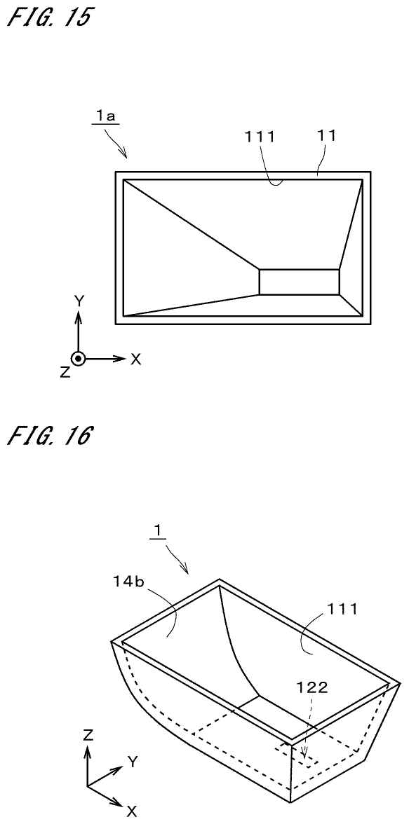

FIG. 15 is a plan view showing an exemplary case in which the characteristic feature of FIG. 14 is applied to a horn antenna la having other structure. The horn antenna la shown in FIG. 15 has no horn bottom surface 121. The bottom of the horn 11, i.e., an end portion on a (−Z) side is entirely opened. The waveguide tube extends in the Z direction. The opening in the bottom of the horn 11 is also an opening of the waveguide tube. The opening in the bottom of the horn 11 is an opening of the horn inner surface 111 on the (−Z) side. Hereinafter, the opening of the horn inner surface 111 on the (−Z) side is referred to as a “(−Z) side opening”. The opening of the horn inner surface 111 on a (+Z) side is referred to as a “(+Z) side opening”.

In a plan view, a position of the center of the (−Z) side opening deviates from the center of the (+Z) side opening. It is thereby possible to incline the direction of the radio wave to be emitted by the simple structure. The position of the center of the (−Z) side opening deviates from the center of the (+Z) side opening in the (+X) direction and the (−Y) direction. The position of the center of the (−Z) side opening may deviate from the center of the (+Z) side opening only in the (+X) direction. As a matter of course, the shape of the (−Z) side opening and the shape of the (+Z) side opening in a plan view are not limited to a rectangular shape but may have an ellipse, a circle, a rectangular shape having a large chamfer, a square, or the like.

By deviating the position of the center of the (−Z) side opening from the center of the (+Z) side opening in any one of various directions in a plan view, it is possible to change the direction of the radio wave to be emitted in various manners. In a case where the (−Z) side opening and the (+Z) side opening are long in the X direction, particularly, by deviating the position of the center of the (−Z) side opening from the center of the (+Z) side opening in the X direction and the Y direction, it is possible to obtain a radio wave having radiation characteristics which cannot be obtained conventionally.

FIG. 16 is a perspective view showing another variation of the horn antenna 1 shown in FIG. 12. In the horn antenna 1 of FIG. 16, the portion 14b of the horn inner surface 111, which rises from the position farthest away from the radiation part 122, is concave. Exactly, the portion 14b has a concave surface in which a cross section taken by a plane in parallel with the ZX plane is concave. It is thereby possible to expand a radiation range of the radio wave in the X direction while inclining the radiation direction of the radio wave. As a matter of course, the other portions of the horn inner surface 111 may be concave, but it is preferable that at least the portion 14b which is inclined most should be concave. The concave surface may be formed by combining a plurality of planes.

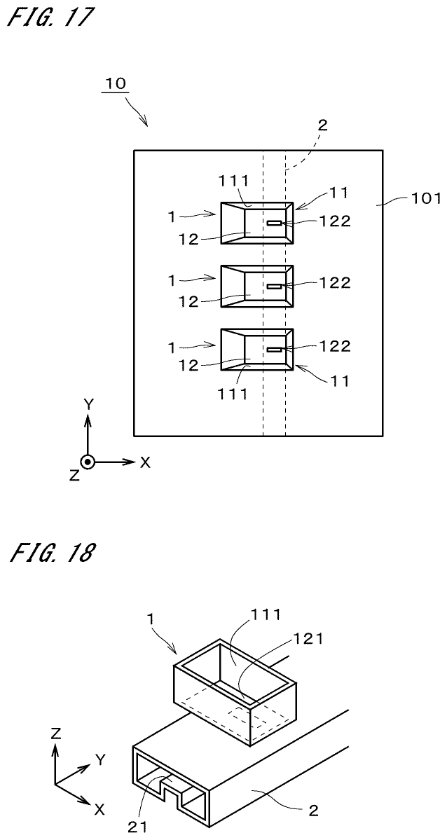

FIG. 17 is a plan view showing an antenna array 10 including a plurality of horn antennas 1. The shape of the horn inner surface 111 in each horn antenna 1 is the same as that in the horn antenna 1 of FIG. 12. The horn inner surface 111 of each horn antenna 1 is formed by cutting part of a thick plate-like conductive member 101. As a matter of course, the horn inner surface 111 may be formed by any other processing method. The plurality of horn antennas 1 are arranged in the Y direction. Like in the exemplary case of FIG. 1, the waveguide 2 extends in the Y direction. Instead of the waveguide 2 which is a waveguide tube, a waveguide having any other structure may be adopted. The waveguide 2 may be formed by, for example, providing another conductive member with a ridge protruding in a ridge-like manner and making the ridge closer to a back surface of the conductive member 101. As to the point that any one of various waveguides may be adopted, the same applies to the horn antenna 1 in accordance with other example embodiments.

In the antenna array 10, the waveguide 2 extends in the Y direction and the radiation part 122 of each horn antenna 1 is positioned on the waveguide 2. Since each horn 11 and the horn bottom 12 are long in the X direction, the plurality of horn antennas 1 can be easily arranged in the Y direction. It is thereby possible to emit a radio wave of high intensity while being inclined. Further, since the radiation direction of the emitted radio wave is the X direction, the horn antennas 1 can be arranged without taking the radiation direction of the radio wave into consideration. It is preferable that the plurality of horn antennas 1 should be aligned in the Y direction.

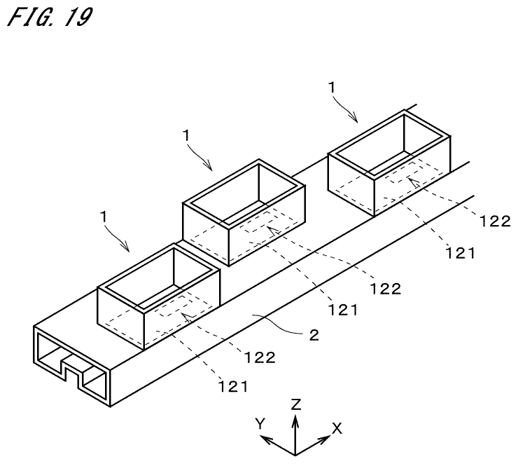

FIG. 18 is a perspective view showing another preferable example of the waveguide 2. The waveguide 2 shown in FIG. 18 is a tubular waveguide tube extending in the Y direction. A portion of the waveguide 2 on the (−Z) side, i.e., a portion on a side opposite to the horn antenna 1 includes a ridge 21 extending in the Y direction. The ridge 21 has a ridge-like shape protruding toward the inside of the waveguide tube. Though only one horn antenna 1 is shown in FIG. 18, a plurality of horn antennas 1 may be arranged in the Y direction like in the exemplary case of FIG. 17. In the horn antenna 1 of FIG. 18, the horn inner surface 111 is entirely in parallel with the normal of the horn bottom surface 121.

FIG. 19 is a perspective view showing another exemplary case where the plurality of horn antennas 1 are arranged on the waveguide 2. When the XYZ directions are determined like in FIG. 1 with the orientation of the horn antenna 1 as a reference, the waveguide 2 extends in the X direction. The radiation part 122 deviates from the center of the horn bottom surface 121 in the (+X) direction. The shape of the waveguide 2 is the same as that in FIG. 18. In FIG. 19, the plurality of horn antennas 1 are arranged in the X direction while deviating alternately in the (+Y) direction and the (−Y) direction. In other words, the plurality of horn antennas 1 are arranged in the X direction in a staggered manner.

In the exemplary case of FIG. 19, when an electric field moves toward the (+X) direction, the plurality of radiation parts 122 which are slots alternately interfere with currents flowing inside the waveguide tube at a position on the (+Y) side and another position on the (−Y) side, to thereby emit a radio wave from each radiation part 122. The interval of the radiation parts 122 in the X direction is set as appropriate in accordance with the inclination of the radiation direction of the radio wave.

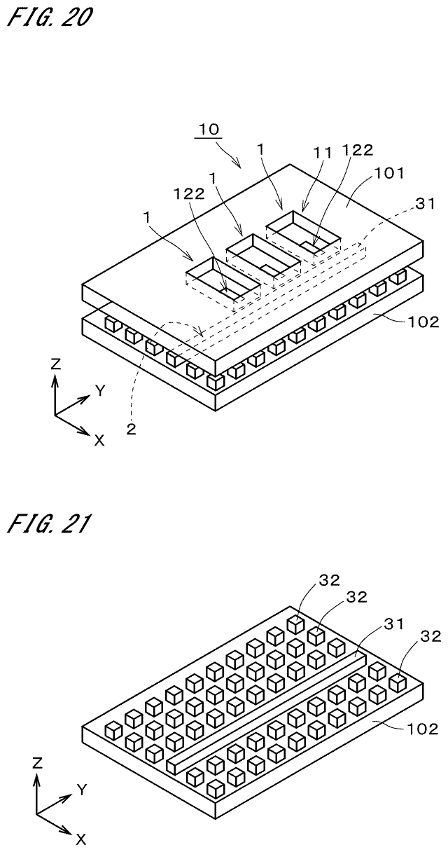

FIG. 20 is a perspective view showing still another example of the waveguide 2 together with the antenna array 10. Each horn antenna 1 in the antenna array 10 is a horn antenna 1 where a horn 11 is formed by hollowing out part of the thick plate-like conductive member 101, like in the exemplary case of FIG. 17. As the horn antenna 1, any one of the other horn antennas 1 described earlier or a horn antenna having still another shape may be adopted.

Another conductive member 102 is disposed on a lower side, i.e., on the (−Z) side of the conductive member 101. FIG. 21 is a perspective view of the conductive member 102. The conductive member 102 includes a ridge 31 and a plurality of rods 32. The ridge 31 extends in the Y direction. The ridge 31 protrudes upward from an upper surface of the conductive member 102 in a ridge-like form. As shown in FIG. 20, the ridge 31 is positioned immediately below the radiation parts 122 of the plurality of horn antennas 1. The plurality of rods 32 protrude upward from the upper surface of the conductive member 102 in a columnar form. The ridge 31 is positioned between the plurality of rods 32. The ridge 31 and the rods 32 are conductive portions provided as part of the conductive member 102. The shapes of the conductive member 101 and the conductive member 102 are not limited to the plate-like shape. The ridge 31 has the same height and width as those of the rod 32. Further, the height and width of the ridge 31 may have different values from those of the rod 32.

On both sides of the rod 32, a space between a surface of each rod 32 and a conductive surface (a surface opposed to the conductive member 102) of the conductive member 101 does not propagate an electromagnetic wave having a frequency within a specific frequency band. Such a frequency band is termed a “prohibited band”. The height and size of the rod 32 and the interval of the rods 32 are designed so that the frequency of the electromagnetic wave propagating in a waveguide device may be included in the prohibited band. A space (gap) between the conductive surface of the conductive member 101 and an upper surface of the ridge 31 becomes the waveguide 2. For example, the electromagnetic wave in a millimeter wave band is propagated in this space between the conductive surface and the upper surface of the ridge 31 along the ridge 31. Though the rod 32 has a prism-like shape in the exemplary case shown in this figure, the rod 32 is not limited to be prismatic but may be, for example, cylindrical.

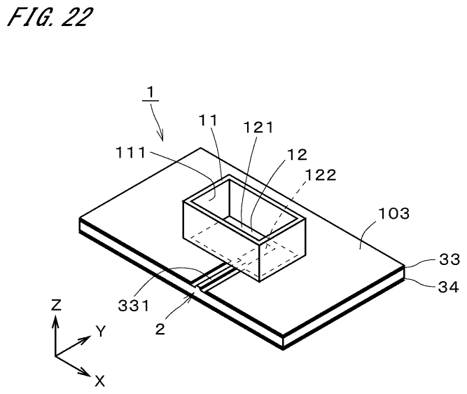

FIG. 22 is a perspective view showing still another example embodiment of the horn antenna 1. The horn antenna 1 of FIG. 22 has a patch which is a radiation element, as the radiation part 122. The radiation part 122 is a conductive thin plate or thin film. The radiation part 122 has a rectangular shape which is long in the Y direction. The shape of the horn 11 is the same as that in FIG. 18. As the horn 11, any one of various shapes described earlier or a still another shape may be adopted.

The horn 11 and the radiation part 122 are arranged on a substrate 103. On an upper surface and a lower surface of the substrate 103, conductive layers 33 and 34 are provided, respectively. A portion between the two conductive layers 33 and 34 is a dielectric. An area around the radiation part 122 is an area obtained by removing part of the conductive layer 33. In other words, by removing part of the conductive layer 33, the radiation part 122 is formed. A power supply line 331 extends from the radiation part 122 in the (−Y) direction. An area around the power supply line 331 is also an area obtained by removing part of the conductive layer 33. An electromagnetic wave is propagated between the power supply line 331 and the conductive layer 34 on the lower surface toward the radiation part 122. In other words, the waveguide 2 extending in the Y direction is formed of the power supply line 331 and the conductive layer 34.

The horn bottom 12 is a portion of the substrate 103, which is positioned inside the horn 11. The horn bottom 12 includes the horn bottom surface 121. Like in the exemplary case of FIG. 1, the position of the radiation part 122 deviates from the center of the horn bottom surface 121. Preferably, the horn bottom surface 121 is long in the X direction which is the first direction. The position of the radiation part 122 deviates from the center of the horn bottom surface 121 in the X direction. It is thereby possible to incline the radiation direction of the radio wave by the simple structure like in the exemplary case of the horn antenna 1 shown in FIG. 1. At least part of the horn bottom surface 121 is present between the radiation part 122 and the horn inner surface 111. With the presence of the horn bottom surface 121, it is possible to easily ensure the bandwidth.

Further, the shape of the horn inner surface 111 may be changed into various forms as described earlier. In other words, the radiation part 122 may be changed to the conductive patch in the above-described horn antenna 1 in which the radiation part 122 is a slot.

As described earlier, the shape of the horn bottom surface 121 may be changed into various forms. The shape of the horn bottom surface 121 is not limited to a bilaterally symmetrical figure. The position of the center of the horn bottom surface 121 may be determined as the center of a circumscribed circle or the center of a minimum bounding rectangle (MBR). Similarly, the shape of the radiation part 122 which is a slot or a conductive patch may be changed into various forms. The position of the radiation part 122, i.e., the position of center of the radiation part 122 may be also determined as the center of a circumscribed circle or the center of a minimum bounding rectangle (MBR). The description that the horn bottom surface 121 is “long in the X direction” which is the first direction can be defined in various ways. Typically, this can be defined as the meaning that the longitudinal direction of the minimum bounding rectangle of the horn bottom surface 121 is directed in the X direction.

FIG. 23 is a view showing a constitution of a radar 4 including the above-described horn antenna 1 or antenna array 10. The radar 4 includes a transmitting antenna 41, a receiving antenna 42, a transmitter-receiver circuit 43, and a detection part 44. The transmitting antenna 41 is the above-described horn antenna 1 or antenna array 10. The transmitter-receiver circuit 43 performs control of radiation of a radio wave from the transmitting antenna 41 and processing of a signal from the receiving antenna 42. The detection part 44 detects presence of an object on the basis of the signal from the receiving antenna 42.

The receiving antenna 42 is preferably a horn antenna. As the structure of the receiving antenna 42, any one of various structures may be adopted. For the radar 4, as the receiving antenna 42, the same structure as the transmitting antenna 41 may be adopted. An antenna for performing both transmission and reception may be provided. The transmitter-receiver circuit 43 is typically provided on a circuit board and includes a transmitter circuit and a receiver circuit. The detection part 44 is also implemented by an electric circuit.

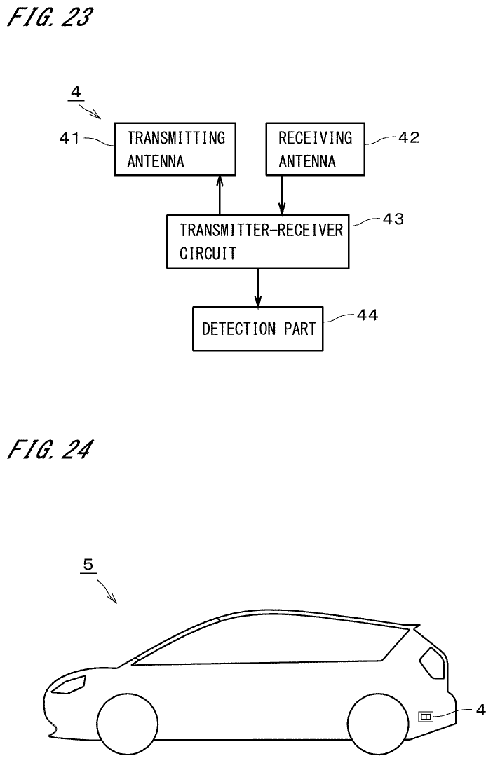

FIG. 24 is a view showing a vehicle 5 including the radar 4. The vehicle 5 is a car. The vehicle 5 may be a vehicle other than a car. The radar 4 is attached onto each of left and right side surfaces of the rear of the vehicle 5. The (+X) direction in the above description corresponds to a front direction of the vehicle. A direction of a radio wave emitted from the radar 4, i.e., a direction of the main lobe is a direction inclined backward from the side of the vehicle. It is thereby possible to achieve monitoring of the diagonal backward direction of the vehicle 5 by the simple structure.

An attachment position of the horn antenna 1 or the antenna array 10 may be changed in various ways in accordance with the purpose. There may be a case, for example, where the horn antenna 1 or the antenna array 10 is attached on the left side of the rear end of the vehicle as the vehicle 5 is viewed from backward and the above-described X direction is the right direction. The radio wave is emitted in a direction of being inclined leftward from the direct backward direction. In a case where the horn antenna 1 or the antenna array 10 is attached on the right side of the rear end of the vehicle, left and right are inverted from the case where the horn antenna 1 or the antenna array 10 is attached on the left side. It is thereby possible to monitor the diagonal backward direction of the vehicle 5 by the simple structure. For example, it is possible to detect a vehicle running on a lane adjacent to a lane on which the vehicle 5 is running. Particularly, it is possible to detect a vehicle approaching from backward of the vehicle 5 with high accuracy.

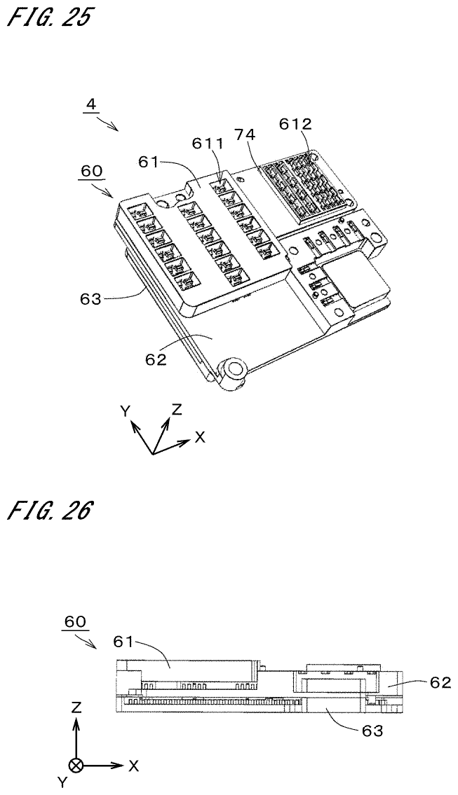

FIG. 25 is a perspective view showing an exemplary appearance of a principal part of the radar 4. FIG. 25 shows a structure 60 in which a circuit board including the transmitter-receiver circuit 43 of FIG. 23 is omitted from the radar 4. The structure 60 is a waveguide device. FIG. 26 is an elevational view of the structure 60 and shows the structure 60 as viewed from the lower right side of FIG. 25, being directed in the left-upward direction, i.e., being directed from the (−Y) side toward the (+Y) direction. The structure 60 includes a first conductive member 61, a second conductive member 62, and a third conductive member 63. The first conductive member 61, the second conductive member 62, and the third conductive member 63 each have a plate-like shape and are stacked in this order from the upper side. A clearance is provided between the first conductive member 61 and the second conductive member 62. A clearance is also provided between the second conductive member 62 and the third conductive member 63. Further, the first conductive member 61, the second conductive member 62, and the third conductive member 63 may partially come into contact with one another.

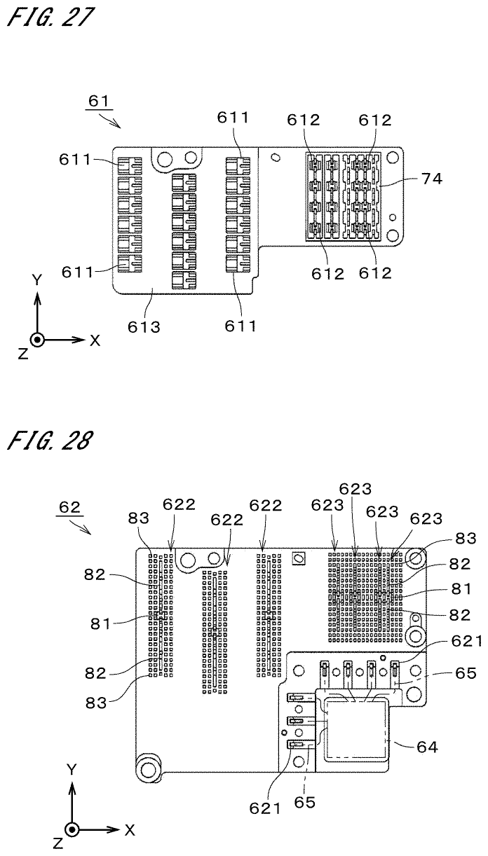

FIG. 27 is a plan view showing the first conductive member 61. FIG. 28 is a plan view showing the second conductive member 62. FIG. 29 is a plan view showing the third conductive member 63. In FIG. 28, an integrated circuit 64 mounted on the circuit board and microstriplines (hereinafter, referred to as “MSLs”) 65 each of which is a waveguide extending from the integrated circuit 64 are represented by two-dot chain lines. The MSLs 65 are formed on the not-shown circuit board. The integrated circuit 64 includes a signal generator circuit and a receiver circuit. In other words, the circuit board includes a function as a signal generator device. The signal generator circuit and the receiver circuit correspond to the transmitter-receiver circuit 43 of FIG. 23. The three MSLs 65 extend from the integrated circuit 64 in the left direction of FIG. 28. The four MSLs 65 extend from the integrated circuit 64 in the upward direction of FIG. 28.

The first conductive member 61 is a radiation layer. As shown in FIG. 28, the first conductive member 61 includes a plurality of transmitting antennas 611 and a plurality of receiving antennas 612. The transmitting antenna 611 is a radiation element. The receiving antenna 612 is a receiving element. When a surface 613 of the first conductive member 61 on the (+Z) side is represented as a “radiation surface”, the radar 4 has the transmitting antennas 611 and the receiving antennas 612 on the radiation surface 613. The radiation surface 613 is a conductive surface. Since the transmitting antennas 611 and the receiving antennas 612 are arranged on the radiation surface 613, the function as a radar antenna can be sufficiently displayed. A surface of the first conductive member 61 on a side opposite to the radiation surface 613 is also conductive and faces the second conductive member 62.

The shape of the transmitting antenna 611 is almost the same as that shown in FIG. 3. Specifically, the radiation part 122 which is a slot has an I shape that is long in the X direction, and the steps 13 are provided at the four corners of the horn inner surface 111 (see reference signs of FIG. 1). In the exemplary case of FIG. 27, the width of the steps 13 in the X direction on the (−X) side is larger than that of the steps 13 in the X direction on the (+X) side. As the transmitting antenna 611, any one of various horn antennas described above may be adopted. The transmitting antennas 611 are arranged in three rows. In each row, six transmitting antennas 611 are aligned in the Y direction. The number of rows of the transmitting antennas 611 and the number of transmitting antennas 611 included in each row are not limited to those in the exemplary case of FIG. 27. The horn of each transmitting antenna 611 is formed by cutting or deforming the first conductive member 61 like in the case of FIG. 20.

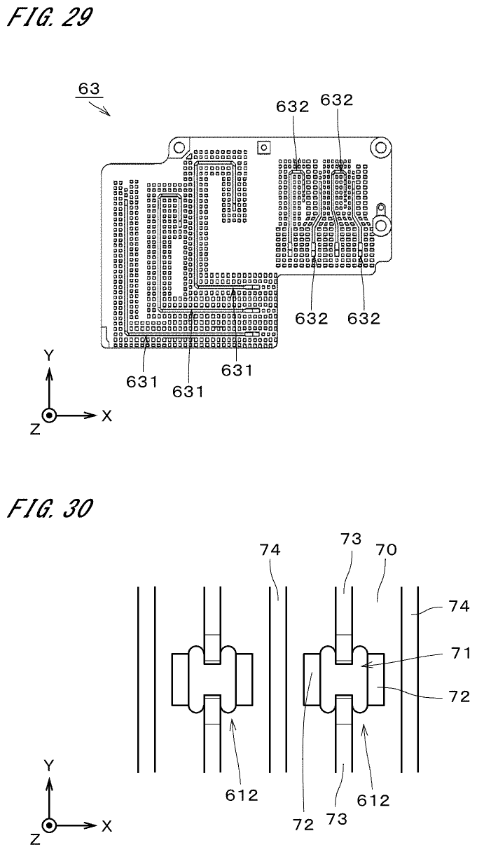

FIG. 30 is an enlarged view of the receiving antennas 612. FIG. 30 shows two receiving antennas 612 that are part of the two rows on the left side among the receiving antennas 612 shown in FIG. 27. The receiving antenna 612 is a so-called ridge horn antenna. The receiving antenna 612 has a slot 71 at the center. The slot 71 is an H-shaped opening provided in a bottom surface 70. On the (+X) side and (−X) side of the slot 71, provided are sidewalls 72 protruding from the bottom surface 70 toward the (+Z) direction. The sidewalls 72 are provided only on both the sides of the slot 71.

On the (+Y) side and (−Y) side of the slot 71, provided are ridges 73 extending in the Y direction from an upper portion and a lower portion of the center of the slot 71. The ridges 73 protrude from the bottom surface 70 toward the (+Z) direction. Each of the ridges 73 extends up to another slot 71 adjacent thereto in the Y direction. On the (+X) side and (−X) side of the row of the receiving antennas 612, provided are peripheral walls 74 extending in the Y direction. The peripheral walls 74 protrude from the bottom surface 70 toward the (+Z) direction. As shown in FIG. 27, the peripheral walls 74 surround the periphery of the row of the receiving antennas 612.

Though description of details will be omitted, in the receiving antennas 612 in the two rows on the right side in FIG. 27, only one sidewall 72 is provided between the slots 71 adjacent to each other in the X direction. Therefore, two slots 71 are disposed between the three sidewalls 72 arranged in the X direction. The receiving antennas 612 are arranged in four rows and each row has four receiving antennas 612. Each of the receiving antennas 612 includes the slot 71, the two sidewalls 72, the two ridges 73, and the bottom surface 70. As the receiving antenna 612, any one of other various forms may be adopted.

As shown in FIG. 25, the thickness of an area in which the transmitting antennas 611 of the first conductive member 61 are provided is larger than that of another area in which the receiving antennas 612 are provided. It is thereby possible to make the width of the horn inner surface of the transmitting antenna 611 in the Z direction sufficiently larger than the width of the peripheral wall 74 surrounding the receiving antennas 612 in the Z direction and easily increase the directivity of the transmitting antenna 611.

The second conductive member 62 shown in FIG. 28 is an excitation layer. The second conductive member 62 has ridge waveguides 621 to which the MSLs 65 are connected, three waffle iron ridge waveguides (hereinafter, referred to as “WRG waveguides”) 622 which are waveguides on the transmitting side, and four WRG waveguides 623 on the receiving side. Each of the ridge waveguides 621 extends toward the third conductive member 63 in the (−Z) direction. The WRG waveguides 622 and 623 have the same structure of FIG. 21, and each of the WRG waveguides has a linear ridge 82 and a large number of conductive rods 83 arranged around the ridge 82. The ridges 82 and the rods 83 are provided on a conductive surface of the second conductive member 62, which is opposed to the first conductive member 61. Exactly, the WRG waveguides 622 and 623 are configured by combining the conductive surface of the first conductive member 61, which is opposed to the second conductive member 62, and the ridges 82 and the rods 83.

In the WRG waveguide 622, a through hole 81 is provided. The through hole 81 has an H shape. The electromagnetic wave transmitted from the MSL 65 is guided from the through hole 81 which is a power supply point to the WRG waveguide 622 through the ridge waveguide 621 and the third conductive member 63. Then, the electromagnetic wave is emitted from the slot of the transmitting antenna 611. On the other hand, the electromagnetic wave received by the receiving antenna 612 is guided from the slot 71 shown in FIG. 30 to the WRG waveguide 623, and then guided from the through hole 81 to the MSL 65 through the third conductive member 63 and the ridge waveguide 621.

The third conductive member 63 shown in FIG. 29 is a distribution layer. On the conductive surface of the third conductive member 63 on the side of the second conductive member 62, provided are ridges and a large number of rods. Three WRG waveguides 631 on the transmitting side and four WRG waveguides 632 on the receiving side are thereby provided, together with the conductive surface of the second conductive member 62, which is opposed to the third conductive member 63. Each ridge has one or more bent portions. The respective lengths of the ridges in the WRG waveguide 631 on the transmitting side are different. The three WRG waveguides 631 extend from the three ridge waveguide 621 of the second conductive member 62 up to the through holes 81 of the second conductive member 62 on the transmitting side. With the above-described configuration, it is possible to supply the electromagnetic waves having different phases to the plurality of through holes 81 of the second conductive member 62.

The first conductive member 61, the second conductive member 62, and the third conductive member 63 are formed by, for example, processing a metal plate. Though the structure 60 which is a waveguide device is formed of the three conductive members 61 to 63 in FIG. 25, the number of conductive members forming the waveguide device is not limited to 3.

Various horn antennas described in the above-described example embodiment can be used for a communication technology which is called the Massive MIMO (Multiple Input Multiple Output). The Massive MIMO is a MIMO technology for achieving an active antenna having high directivity by using 100 or more antenna elements.

The above-described horn antenna 1, antenna array 10, and radar 4 allow various variations.

The shape of the horn bottom surface 121 is not limited to a shape which is long in one direction. For example, the horn bottom surface 121 may be square. The position of the radiation part 122 may deviate from the center of the horn bottom surface 121 in a direction other than the longitudinal direction of the horn bottom surface 121. In FIGS. 1, 12, or the like, for example, the radiation part 122 may deviate from the center of the horn bottom surface 121 in the Y direction.

The horn bottom surface 121 may be present all around the circumference of the radiation part 122, or may be present only on one direction side of the radiation part 122. The horn bottom surface 121 has only to be present at some portion in the circumference of the radiation part 122, and it is thereby possible to ensure the bandwidth of a radio wave.

The step 13 shown in FIGS. 1, 3, 7, or the like may have one stage. Instead of the step 13, an inclined surface may be provided. The normal of an inclined surface between the horn inner surface 111 and the radiation part 122 is preferably in parallel with the YZ plane and inclined toward the side of the radiation part 122. The inclined surface can be understood as the step 13 having a large number of stages.

As the radiation part 122, any structure other than the slot or the patch may be adopted. The shape of the slot or the patch may be changed into various forms.

The configurations in the above-discussed example embodiment and variations may be combined as appropriate only if those do not conflict with one another.

The present disclosure can be used for various uses of the horn antenna. Preferably, the horn antenna can be used for a radar mounted on a vehicle.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A horn antenna, comprising:
a horn including a horn inner surface; and
a horn bottom including a horn bottom surface, wherein
the horn bottom includes a radiation portion which emits a radio wave at a position that deviates from a center of the horn bottom surface.

2. The horn antenna according to claim 1, wherein
the horn bottom surface is longer in a first direction than in a second direction which is in parallel or substantially parallel with the horn bottom surface and perpendicular to substantially perpendicular to the first direction, and
the position of the radiation portion deviates from the center of the horn bottom surface in the first direction.

3. The horn antenna according to claim 1, wherein
the horn bottom surface is longer in a first direction than in a second direction which is in parallel or substantially in parallel with the horn bottom surface and perpendicular or substantially perpendicular to the first direction,
the position of the radiation portion deviates from the center of the horn bottom surface in the first direction,
the radiation portion is a slot which is opened in the horn bottom surface, and
a direction of supplying power to the slot is the second direction.

4. The horn antenna according to claim 1, wherein
the horn bottom surface is longer in a first direction than in a second direction which is in parallel or substantially in parallel with the horn bottom surface and perpendicular or substantially perpendicular to the first direction,
the position of the radiation portion deviates from the center of the horn bottom surface in the first direction,
the radiation portion is a slot which is opened in the horn bottom surface,
the slot has an H shape including a lateral portion extending in the first direction and a pair of vertical portions, and
the pair of vertical portions are connected by the lateral portion.

5. The horn antenna according to claim 1, further comprising:
a step which protrudes from the horn bottom surface and the horn inner surface, the step being provided between the radiation portion and the horn inner surface in a second direction which is in parallel or substantially in parallel with the horn bottom surface and perpendicular or substantially perpendicular to a first direction.

6. The horn antenna according to claim 1, further comprising:
a step which protrudes from the horn bottom surface and the horn inner surface, the step being provided between the radiation portion and the horn inner surface in a second direction which is in parallel or substantially in parallel with the horn bottom surface and perpendicular or substantially perpendicular to a first direction, wherein
the horn bottom surface is longer in the first direction than in the second direction which is in parallel or substantially in parallel with the horn bottom surface and perpendicular or substantially perpendicular to the first direction, and
the position of the radiation portion deviates from the center of the horn bottom surface in the first direction.

7. The horn antenna according to claim 1, further comprising:
a step which protrudes from the horn bottom surface and the horn inner surface, the step being provided between the radiation portion and the horn inner surface in a second direction which is in parallel or substantially in parallel with the horn bottom surface and perpendicular or substantially perpendicular to a first direction, wherein
the horn bottom surface is longer in the first direction than in the second direction which is in parallel or substantially in parallel with the horn bottom surface and perpendicular or substantially perpendicular to the first direction,
the position of the radiation portion deviates from the center of the horn bottom surface in the first direction,
the radiation portion is a slot which is opened in the horn bottom surface,
the slot has an H shape including a lateral portion extending in the first direction and a pair of vertical portions, and
the pair of vertical portions are connected by the lateral portion.

8. The horn antenna according to claim 1, wherein
a portion of the horn inner surface, which rises from a position closest to the radiation portion, is in parallel or substantially in parallel with a normal of the horn bottom surface or inclined toward a direction becoming farther away from the normal as it becomes farther away from the horn bottom surface, and
a portion of the horn inner surface, which rises from a position farthest away from the radiation portion, is inclined more than another portion of the horn inner surface, which rises from the position closest to the radiation portion, toward a direction becoming farther away from the normal of the horn bottom surface as it becomes farther away from the horn bottom surface.

9. The horn antenna according to claim 1, wherein
the horn bottom surface is longer in a first direction than in a second direction which is in parallel or substantially in parallel with the horn bottom surface and perpendicular or substantially perpendicular to the first direction,
the position of the radiation portion deviates from the center of the horn bottom surface in the first direction,
a portion of the horn inner surface, which rises from a position closest to the radiation portion, is in parallel or substantially in parallel with a normal of the horn bottom surface or inclined toward a direction becoming farther away from the normal as it becomes farther away from the horn bottom surface, and
a portion of the horn inner surface, which rises from a position farthest away from the radiation portion, is inclined more than another portion of the horn inner surface, which rises from the position closest to the radiation portion, toward a direction becoming farther away from the normal of the horn bottom surface as it becomes farther away from the horn bottom surface.

10. The horn antenna according to claim 8, wherein
at least a portion of the horn inner surface other than the portion which rises from the position farthest away from the radiation portion is in parallel or substantially in parallel with the normal.

11. The horn antenna according to claim 1, wherein
the horn bottom surface is longer in a first direction than in a second direction which is in parallel or substantially in parallel with the horn bottom surface and perpendicular or substantially perpendicular to the first direction,
the position of the radiation portion deviates from the center of the horn bottom surface in the first direction,
a portion of the horn inner surface, which rises from a position closest to the radiation portion, is in parallel or substantially in parallel with a normal of the horn bottom surface or inclined toward a direction becoming farther away from the normal as it becomes farther away from the horn bottom surface,
a portion of the horn inner surface, which rises from a position farthest away from the radiation portion, is inclined more than another portion of the horn inner surface, which rises from the position closest to the radiation portion, toward a direction becoming farther away from the normal of the horn bottom surface as it becomes farther away from the horn bottom surface, and
at least a portion of the horn inner surface other than the portion which rises from the position farthest away from the radiation portion is in parallel or substantially in parallel with the normal.

12. The horn antenna according to claim 8, wherein
the portion of the horn inner surface, which rises from a position farthest away from the radiation portion, is concave.

13. The horn antenna according to claim 8, further comprising:
a step which protrudes from the horn bottom surface and the horn inner surface, the step being provided between the radiation portion and the horn inner surface in a second direction which is in parallel or substantially in parallel with the horn bottom surface and perpendicular or substantially perpendicular to a first direction, wherein
the horn bottom surface is longer in the first direction than in the second direction which is in parallel or substantially in parallel with the horn bottom surface and perpendicular or substantially perpendicular to the first direction,
the position of the radiation portion deviates from the center of the horn bottom surface in the first direction, and
the portion of the horn inner surface, which rises from a position farthest away from the radiation portion, is concave.

14. The horn antenna according to claim 1, wherein
a height of the horn in a direction perpendicular or substantially perpendicular to the horn bottom surface is less than twice a wavelength at a center frequency of a frequency band of a radio wave emitted from or received through the radiation portion.

15. The horn antenna according to claim 1, wherein
the horn bottom surface is longer in a first direction than in a second direction which is in parallel or substantially in parallel with the horn bottom surface and perpendicular or substantially perpendicular to the first direction,
the position of the radiation portion deviates from the center of the horn bottom surface in the first direction, and
a height of the horn in a direction perpendicular or substantially perpendicular to the horn bottom surface is less than twice a wavelength at a center frequency of a frequency band of a radio wave emitted from or received through the radiation portion.

16. The horn antenna according to claim 1, wherein
the horn bottom surface is longer in a first direction than in a second direction which is in parallel or substantially in parallel with the horn bottom surface and perpendicular or substantially perpendicular to the first direction,
the position of the radiation portion deviates from the center of the horn bottom surface in the first direction,
the radiation portion is a slot which is opened in the horn bottom surface,
the slot has an H shape including a lateral portion extending in the first direction and a pair of vertical portions,
the pair of vertical portions are connected by the lateral portion, and
a height of the horn in a direction perpendicular or substantially perpendicular to the horn bottom surface is lower than twice a wavelength at a center frequency of a frequency band of a radio wave emitted from or received through the radiation portion.

17. The horn antenna according to claim 1, further comprising:
a step which protrudes from the horn bottom surface and the horn inner surface, the step is provided between the radiation portion and the horn inner surface in a second direction which is in parallel with the horn bottom surface and perpendicular or substantially perpendicular to a first direction, wherein
the horn bottom surface is longer in the first direction than in the second direction which is in parallel or substantially in parallel with the horn bottom surface and perpendicular or substantially perpendicular to the first direction,
the position of the radiation portion deviates from the center of the horn bottom surface in the first direction, and
a height of the horn in a direction perpendicular or substantially perpendicular to the horn bottom surface is lower than twice a wavelength at a center frequency of a frequency band of a radio wave emitted from or received through the radiation portion.

18. The horn antenna according to claim 1, wherein
the horn bottom surface is longer in a first direction than in a second direction which is in parallel or substantially in parallel with the horn bottom surface and perpendicular or substantially perpendicular to the first direction,
the position of the radiation portion deviates from the center of the horn bottom surface in the first direction,
a portion of the horn inner surface, which rises from a position closest to the radiation portion, is in parallel or substantially in parallel with a normal of the horn bottom surface or inclined toward a direction becoming farther away from the normal as it becomes farther away from the horn bottom surface,
a portion of the horn inner surface, which rises from a position farthest away from the radiation portion, is inclined more than another portion of the horn inner surface, which rises from the position closest to the radiation portion, toward a direction becoming farther away from the normal of the horn bottom surface as it becomes farther away from the horn bottom surface, and
a height of the horn in a direction perpendicular or substantially perpendicular to the horn bottom surface is lower than twice a wavelength at a center frequency of a frequency band of a radio wave emitted from or received through the radiation portion.

19. An antenna array, comprising:
a plurality of horn antennas each according to claim 18, which are arranged in a second direction which is in parallel or substantially in parallel with the horn bottom surface and perpendicular or substantially perpendicular to a first direction; and
a waveguide extending in the second direction, wherein each radiation portion of the plurality of horn antennas is positioned on the waveguide.

20. A radar comprising:
a transmitting antenna which is a horn antenna according to claim 1;
a receiving antenna; and
a transmitter-receiver circuit that performs control of radiation of a radio wave from the transmitting antenna and processing of a signal from the receiving antenna.

21. The radar according to claim 20, wherein
the receiving antenna is a horn antenna,
the radar includes the transmitting antenna and the receiving antenna on a radiation surface of a conductive member.

22. The radar according to claim 21, wherein the conductive member is a first conductive member, and the radar further comprises:
a second conductive member which is an excitation layer that supplies power to a slot that is a radiation portion of the transmitting antenna provided in the first conductive member; and
a third conductive member which is a distribution layer that supplies power to a through hole of the second conductive member.
